(19) United States
(12) Patent Application Publication
(10) Pub. No.: US 2024/0218549 A1
(43) Pub. Date: Jul. 4, 2024

(54) TWO-STEP METHOD FOR FABRICATING A HIERARCHICAL NANOPOROUS METAL STRUCTURE

(71) Applicant: The Hong Kong University of Science and Technology, Hong Kong (CN)

(72) Inventors: Qing CHEN, Hong Kong (CN); Yang LI, Hong Kong (CN); Yingji SANG, Hong Kong (CN)

(21) Appl. No.: 18/398,214

(22) Filed: Dec. 28, 2023

Related U.S. Application Data
(60) Provisional application No. 63/477,825, filed on Dec. 30, 2022.

(51) Int. Cl. C25D 5/50; C25D 3/22; H01M 8/04186; H01M 8/18

(52) U.S. Cl. CPC C25D 5/50; C25D 3/22; H01M 8/04186; H01M 8/188

(57) ABSTRACT

The present invention provides a two-step method to fabricate a nanoporous metal surface layer supported on the macroscopic metallic foam. The porous structure has an average ligament/pore size from dozens to a few hundred nanometers. The prepared monolithic electrode can simultaneously maintain a rigid metallic skeleton for good mechanical integrity, electrical conductive and hydraulic permeability while the porous layer increase surface area and therefore showcases good performance in the flow-cell, such as Zn-Iodide flow cells and electrochemical organic synthesis.

### FIELD OF THE INVENTION

The present invention generally relates to the fields of materials science and electrochemistry, particularly methods for producing hierarchical porous metals with high hydraulic permeability and specific surface area, and their applications in batteries.

### BACKGROUND OF THE INVENTION

In the realm of the contemporary electrochemical industry, the role of monolithic porous electrodes is nothing short of pivotal. These ingenious structures effectively transcend the confines of two-dimensional reaction zones, expanding them into the expansive realm of three dimensions, a transformation that brings about a substantial increase in surface area. The applications of such versatile electrodes span a broad spectrum, encompassing diverse domains ranging from the utilization in flow cells to the intricate world of electrochemical organic synthesis. Their potential impact reverberates across the domains of energy storage and the facilitation of high-value chemical production. The utility of these monolithic porous electrodes in the aforementioned applications necessitates a specific set of characteristics. They must possess high hydraulic permeability, exceptional electrical conductivity, a large surface area, and a profusion of highly efficient catalytic sites.

While one widely-used porous electrode is made by interwoven carbon fiber prepared from high-temperature annealing of Rayon or polyacrylonitrile based fibers. However, the preparation process is of high energy consuming and expensive. Besides, the properties of carbon electrodes, such as pore size, surface composition and structure are difficult to tailor so as to not obtain desirable electrochemical performance (efficiency and reaction rates).

Porous metal electrodes offer promise in applications like flow cells and electrochemical organic synthesis, with copper foam representing a notable example. Metal foam displays an attractive blend of characteristics, including high electrical and thermal conductivity, tunable pore sizes, and robust mechanical properties. Its macroscopic pores within an interconnected skeleton facilitate the flow of electrolytes. Nevertheless, the surface of metal foam, although structurally sound, lacks the requisite ruggedness to provide an ample number of reaction sites. Consequently, the creation of a nanoporous structure on the surface becomes imperative to meet the demands of these applications. Traditionally, the fabrication methods for nanoporous metal are rooted in the preparation of homogeneous alloys through melting metal powders, followed by dealloying to yield the desired nanoporous structure. This process is not only time-consuming but also yields structures with poor structural stability due to the removal of less noble components and thus cannot satisfy the needs for flow cell applications. Thus, the use of porous metal electrodes for flow cell need to resolve the following two issues: the lower hydraulic permeability of nanoporous metal and the low surface area of metal foam.

US2022250352A1 discloses a method for making a three-dimensional hierarchical layered porous copper. The method includes sequentially electrodepositing the Cu layer and Zn layer on the titanium plate, cumulative rolling of composite electroplating layer followed by annealing to obtain a copper-zinc alloy precursor made of B′ phase and a y phase, and electrochemical dealloying of above alloy precursor to obtain three-dimensional hierarchical layered porous copper. The prepared porous Cu has a complex structure containing a first surface layer, an intermediate layer, and a second surface layer stacked in order. The first surface layer includes a plurality of micron-scale pores and a plurality of first nanoscale pores. The intermediate layer includes a plurality of second nanoscale pores. The second surface layer includes the plurality of micron-scale pores and the plurality of first nanoscale pores. The atom percentage of Zn in the alloy should be kept between 55% and 60% to get the hierarchical porous structure and maintain structural robustness. The microscale pores in the surface layer can offer effective channels for mass transfer and nanosized pores can increase the surface area and can be used as the lithium anode current collector.

CN109694965A discloses a method for making copper-based surface porous structure of an embodiment. The manufacturing method includes: adopting a laser alloying technology to obtain a copper-manganese alloy layer on a copper plate using manganese powder as a raw material, chemical dealloying of manganese element in the alloy to obtain the surface porous structure. The surface structure has micron-scale pores, which is metallurgically combined with a copper base. The surface porous structure has a large specific surface area, high thermal conductivity and good electrical conductivity and might be used in heat exchange, catalytic reduction, detection and sensing.

CN102329977A discloses a preparation method for enhanced mechanical strength of nanoporous copper. The production method comprises: preparing a Zn—Cu alloy sheet with the atom percentage of Cu for 30-50% by annealing, immersing the alloy sheet in a mixed solution of NH₄Cl and HCl to obtain the nanoporous copper, soaking nanoporous Cu in deoxidized distilled water to remove residual acid, immersing nanoporous Cu in a mixed solution containing CuSO₄·5H₂O, ethylene diamine, and formaldehyde under a water bath to get the nanoporous copper with enhanced mechanical strength. One embodiment of enhanced porous Cu has a pore size of 60-100 nm and a ligament width of 150-220 nm. The final step can remedy defects in as-prepared porous Cu, thus maintaining good structural integrity and high conductivity.

However, depict the three prior arts mentioned above reporting methods for fabricating nanoporous Cu, the initial process always entails the preparation of a homogeneous Cu-based alloy sheet, which is both time-consuming and energy-intensive. The resulting dealloyed porous Cu exhibits poor structural stability due to the removal of a significant portion of its composition, rendering these electrodes unsuitable for use in flow cells.

Currently, there have been no studies attempting to create a porous structure on the metal foam electrode itself. Consequently, Zn-based flow cells and electrochemical synthesis cells do not exhibit high efficiency, fast kinetics, or long-term stability. This invention addresses this need.

### SUMMARY OF THE INVENTION

The present method applies two steps of electrochemical reactions to fabricate a layer of nanoporous metal on top of a metallic structure of open pores larger than one micron (e.g., an open-cell metallic foam). The as-fabricated nanoporous structure, which is supported on the macroscopic metal substrate surface, can significantly increase the surface area while maintaining good fluid permeability and structural stability. The utilization of these porous metal electrodes in flow cells and electrochemical organic synthesis represents a novel approach. Both the straightforward fabrication methods and the promising electrochemical performance have the potential to make them highly attractive for widespread application.

In a first aspect, the present invention provides a two-step method for fabricating a hierarchical nanoporous metal structure, including the following steps:
forming a sacrificial material on a metallic structure, with the intention of forming a precursor alloy through annealing; and
dealloying the precursor alloy and the sacrificial material is removed to create a desired hierarchical nanoporous structure.

In one of the embodiments, the metallic structure has open pores larger than 1 micron.

In one of the embodiments, the metallic structure includes open-cell a metallic foam, a metallic foil, or a metallic mesh. The metallic structure can be made of copper, nickel, silver, tin, and their alloys.

In one of the embodiments, the sacrificial material includes zinc, tin, and other element that can form a homogeneous alloy precursor with the metal of the metallic structure.

In a second aspect, the present invention provides a two-step method for fabricating a hierarchical nanoporous metal structure, including the following steps:
forming a thin layer of insoluble compounds on a metallic structure and utilizing the insoluble compounds as a precursor; and
removing one or more anionic components from the insoluble compound via a reduction process to create a desired hierarchical nanoporous structure.

In one of the embodiments, the metallic structure has open pores larger than 1 micron.

In one of the embodiments, the metallic structure includes open-cell a metallic foam, a metallic foil, or a metallic mesh. The metallic structure can be made of copper, nickel, silver, and other metals and alloys.

In one of the embodiments, the insoluble compound is selected from metal oxides, sulfides, and hydroxides.

In a third aspect, the present invention provides a Zn-Iodide redox flow cell, which includes an anode comprising at least one hierarchical nanoporous metal structure; at least one counter electrode as an cathode; a separator positioned between the cathode and the anode; an electrolyte consisting of a catholyte and an anolyte; and a pump for propelling the electrolytes.

In one of the embodiments, the cathode includes a layer of nanoporous metal on top of a metallic structure of with open pores larger than one micron.

In one of the embodiments, the hierarchical nanoporous metal structure possesses an average ligament size or a pore size of 50 nm to 200 nm.

In one of the embodiments, the at least one counter electrode includes carbonous electrode or Pt foil electrode.

In one of the embodiments, the Zn-Iodide redox flow cell further includes at least one electrolyte tank for holding the electrolyte.

In one of the embodiments, the electrolyte includes a neutral based solution.

The Zn-Iodide redox flow cell exhibits a coulombic efficiency of at least 97%, an energy efficiency of at least 75%, and a capability to operate through more than 100 cycles.

Preferably, the Zn-Iodide redox flow cell exhibits an energy efficiency of at least 80% at the current density in a range of 20 mA cm⁻² to 40 mA cm⁻².

### BRIEF DESCRIPTION OF THE DRAWINGS

Embodiments of the invention are described in more details hereinafter with reference to the drawings, in which:

FIG. 1 shows an appearance of porous Cu foam;

FIG. 2 shows a SEM image of macroscopic structure of porous Cu foam;

FIG. 3 shows a SEM image of structure of porous Cu foam;

FIG. 4 shows a simple schematic diagram of the Z-I cell configuration;

FIG. 5A shows a SEM image of Zn deposited on Cu foam;

FIG. 5B shows a SEM image of Zn deposited on porous Cu foam;

FIG. 6 depicts a voltage profile of Zn-I cell operated at 60 mA cm⁻² and 60 mAh cm⁻²;

FIG. 7 shows the coulombic Efficiency (CE) of Zn-I cell operated at 60 mA cm-2 and 60 mAh cm⁻²;

FIG. 8 shows the energy efficiency (EE) of Zn-I cell operated at 60 mA cm⁻² and 60 mAh cm⁻²;

FIG. 9 depicts the rate performance of Zn-I cell operated at different rates;

FIG. 10 depicts polarization curves test of Zn-I flow cell and corresponding power density;

FIG. 11 shows a SEM image of the structure of nanoporous Cu; and

FIG. 12 shows the faradaic efficiency and productivity results of porous Cu electrode under different potentials with 10 mL min-1 flow rate.

### DETAILED DESCRIPTION

In the following description, hierarchical porous Cu electrode and Zn-Iodide redox flow cells are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention applies two-step methods of electrochemical reactions to fabricate a layer of nanoporous metal on top of a metallic structure of open pores larger than one micron (e.g., an open-cell metallic foam). In one embodiment, the first step involves electroplating a sacrificial material to be alloyed (via annealing) with a substrate metal. The as-form alloy serves as the precursor for the second step of selective dissolution that removes the sacrificial material to render the nanoporous structure. The cathodic charge in the first step can be used to control the volume fraction of the nanoporous metal.

In an alternative embodiment of this inventive method, the first step is characterized by the electrodeposition of a thin layer of an insoluble compound. The as-form compound serves as the precursor for the second step of selective dissolution that removes the anionic component from the compound to render the nanoporous structure. The cathodic charge in the first step can be used to control the volume fraction of the nanoporous metal.

Such a hierarchical structure retains the high hydraulic permeability of the micron-sized pores while boosting the specific area of the material, which suits the need for electrodes in flow cells. As fabricated hierarchical porous Cu achieves high energy efficiencies and reaction rates in a Zn-I₂ flow cell and an electro-organic synthesis flow cell, respectively.

The dealloying methods are not limited to electrochemical or wet chemical processes.

In one of the embodiments, the metallic structure has open pores in a range of 1-200 micron.

In one of the embodiments, the metallic structure includes open-cell a metallic foam, a metallic foil, or a metallic mesh. In particular, the metallic structure can be made of copper, nickel, silver, tin, and their alloys.

In one of the embodiments, the sacrificial material may be zinc, tin, and other element that can form a homogeneous alloy precursor with the metal of the metallic structure.

The volume fraction of nanoporous metal is controlled during the first step by modulating the cathodic charge.

In one of the embodiments, the insoluble compound may be a metal oxide, a sulfide, or a hydroxide.

The reduction processes commonly employed in this field can be utilized in the present invention.

The present invention also provides a Zn-Iodide redox flow cell, which includes a cathode comprising at least one hierarchical nanoporous metal structure; at least one counter electrode as an anode; a separator positioned between the cathode and the anode; an electrolyte consisting of a catholyte and an anolyte; and a two-channel peristaltic pump for propelling the electrolyte.

In one of the embodiments, the cathode includes a layer of nanoporous metal on top of a metallic structure of with open pores larger than one micron.

In one of the embodiments, the hierarchical nanoporous metal structure possesses an average ligament size or a pore size of 50 nm to 200 nm.

In one of the embodiments, the at least one counter electrode includes carbonous electrode or Pt foil electrode.

In one of the embodiments, the Zn-Iodide redox flow cell further includes at least one electrolyte tank for holding the electrolyte.

In one of the embodiments, the electrolyte includes a neutral aqueous solution such as a solution of zinc iodide and potassium iodide.

The Zn-Iodide redox flow cell exhibits a coulombic efficiency of at least 97%, an energy efficiency of at least 75%, and a capability to operate through more than 100 cycles.

Preferably, the Zn-Iodide redox flow cell exhibits an energy efficiency of at least 80% at the current density in a range of 20 mA cm⁻² to 40 mA cm⁻².

### EXAMPLE

### Example 1

### Hierarchical Porous Cu-Based on Dealloying Cu—Zn Alloy

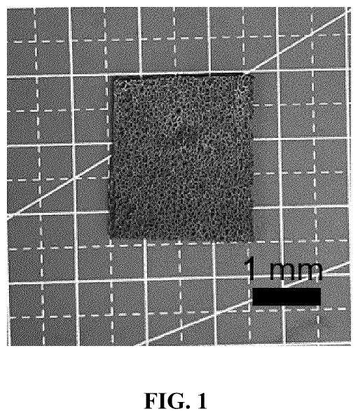

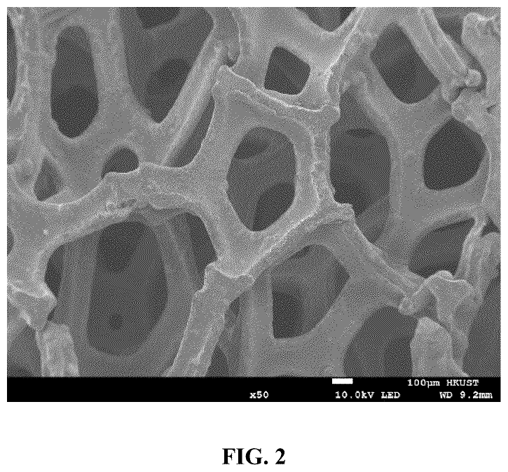

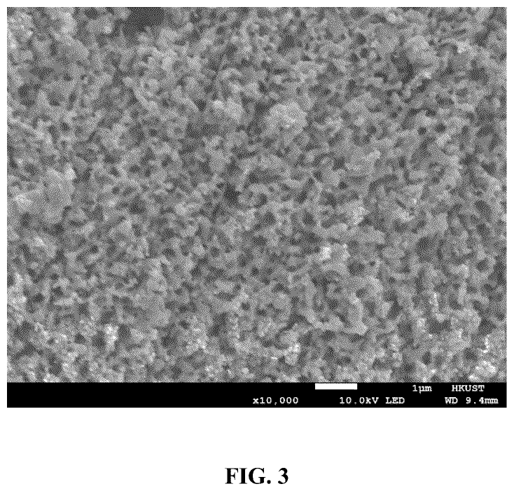

A hierarchical porous Cu was fabricated by wet-chemical dealloying the Cu—Zn alloy. Firstly, metallic Zn was electroplated on the surface of a Cu foam by galvanostatic method with a current density of 5 mA cm⁻² for 20 min in the electroplating bath containing 0.6 M zinc sulfate heptahydrate, 0.01 M sodium dodecyl sulfate, and 0.1 M ammonium sulfate. Then, the electrode was annealed at 200° ° C. under the argon environment for 2 hr to get the Cu—Zn alloy electrode. Afterward, the alloy electrode was immersed in 1 M NaOH aqueous solution to dealloy Zn under 50° C. with stirring. The dealloying usually lasted 6-12 hr and then electrode was rinsed with water and immersed in 0.5 M sulfuric acid to remove the top layer of Cu oxides. The final electrode was thoroughly washed with water and dried with nitrogen gas. The hierarchical porous electrode was directly used as the anode material in Zn-I₂ redox flow cells. The appearance and resultant morphology of the porous Cu foam were examined with scanned electron microscopy (SEM) in FIGS. 1-3.

### Example 2

Zn-Iodide redox flow cells with hierarchical porous Cu electrode

One known commercial Zn-Br₂ redox flow cells current available is from Primus power in the US. However, they use titanium as the electrode yet their low porosity and low affinity cannot deposit enough Zn, leading to low energy yet will be revamped once adopting the present art as the electrode for Zn deposition. Besides, the corrosive and low solubility will be the limiting factor for high energy and long-life Zn-Br₂ cell while these barriers can be removed in the Zn-I₂ redox flow cells.

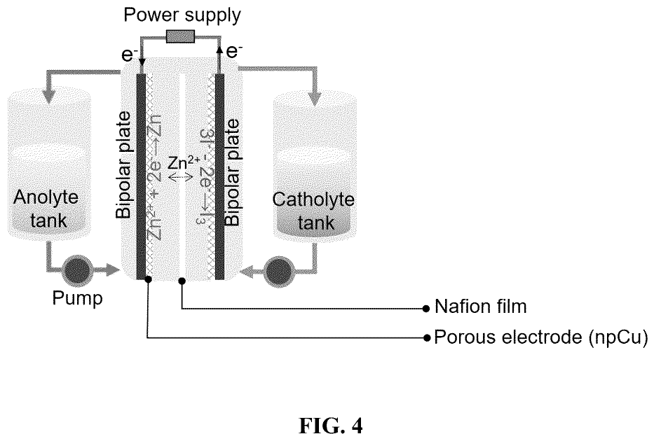

A flow-through configuration was employed to assemble the flow cell (FIG. 4). The investigation into the typical cycle life and rate capability of the Zn-I flow cell was conducted, utilizing the porous Cu electrode for Zn plating and stripping within the negative half-cell. The negative half-cell of the cell was equipped with a porous Cu electrode, while the positive half-cell featured graphite felt. The two cells were separated by a commercial Nafion 212 membrane. The electrolyte consisted of 1 M ZnI aqueous solution and was circulated using a two-channel peristaltic pump (Longer pump, WT600-2J) at a flow rate of 46 mL min⁻¹.

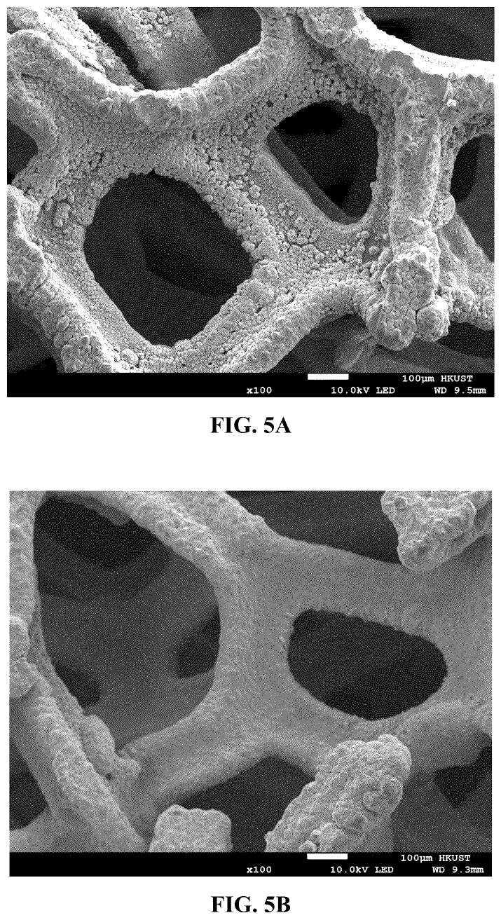

FIG. 5A and FIG. 5B showed the morphology of Zn-deposited on Cu foam and porous Cu electrode with the areal capacity of 10 mAh cm⁻² at a current density of 60 mA cm⁻² in real flow cell. Uneven and dendritic Zn appeared on the surface of Cu foam but remained neat on porous Cu foam. This might relate to more nucleation sites on porous Cu.

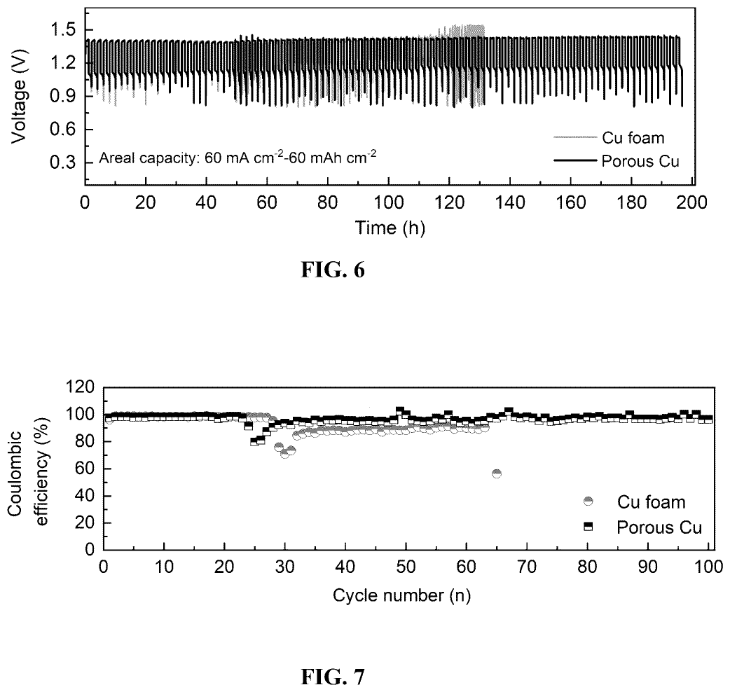

The cell was galvanostatically cycled at a designated charge/discharge current. Charging protocol was limited by both the areal capacity of 60 mAh cm⁻² and voltage cutoff of 1.55 V, while the discharge voltage cutoff was set at 0.8 V. All electrochemical test was performed under room temperature (approximately 22° C.). FIG. 6 showed the voltage profile of Zn-I₂ flow cell operated at a current density of 60 mA cm⁻² and areal capacity of 60 mAh cm⁻². The cell stably operated for more than 100 cycles (approximately 200 hr) with the demonstration of reversible charge and discharge curves.

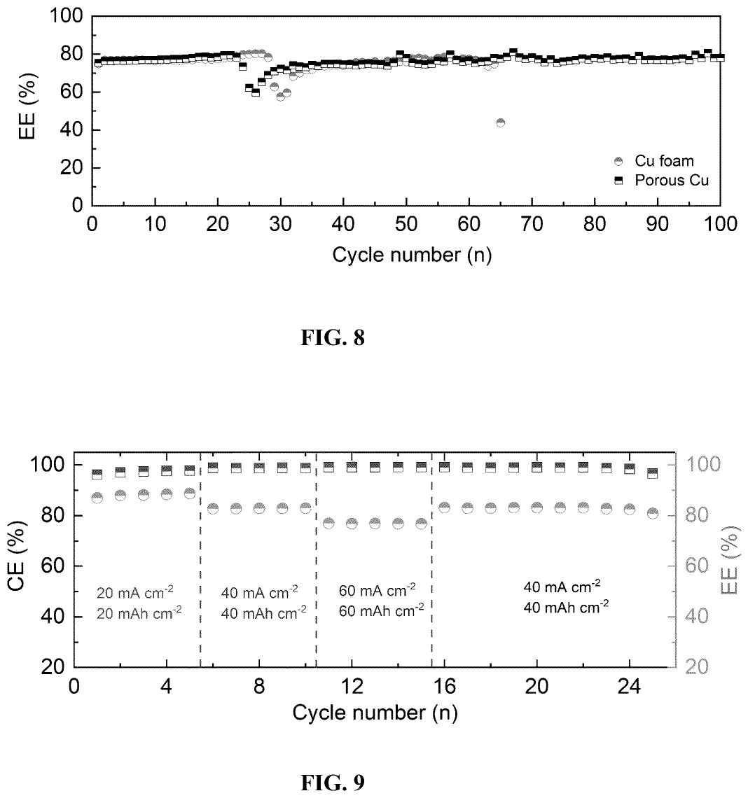

FIG. 7 and FIG. 8 showed the variations the coulombic efficiency (CE) and energy efficiency (EE) across different cycles. The results revealed that the average CEs of the Zn-I cell equipped with porous Cu electrode were beyond 97% and their EEs remained as high as 77.5%, which showed stable performance over 100 cycles. In contrast, the cell using Cu foam failed after only 65 cycles due to the formation of destructive dendrites.

The cell performance at different rates was further evaluated. As shown in FIG. 9, the cell exhibited good rate capability and achieve all CEs above 97% at different rates. The EEs were as high as 88.4% and 82.9% at the current density of 20 mA cm⁻² and 40 mA cm⁻², respectively.

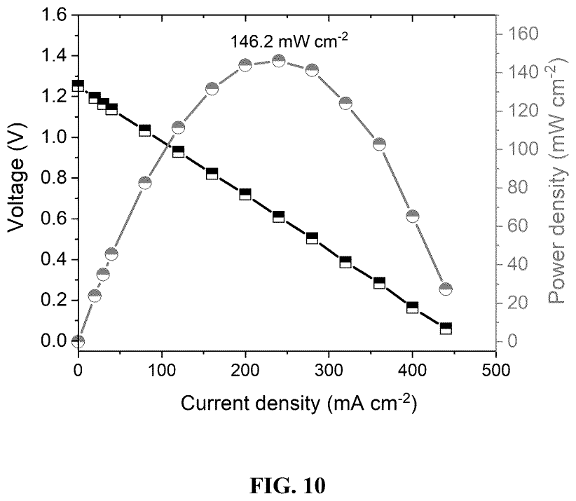

Referring to FIG. 10, The polarization test revealed a higher limiting current density of 440 mA cm⁻² and a maximum power density of 146.2 mW cm⁻², mainly arising from the merits of hierarchical bicontinuous structure, which facilitated rapid electron transfer and ion transport. Cu foam skeleton maintained excellent electronic conductivity, electrolyte permeability and structural integrity. Meanwhile, the surface porous layer increased the surface area, thereby offering a greater number of reaction sites for Zn electrodeposition.

### Example 3

### Hierarchical Porous Cu Based on the Reduction of Copper Oxides

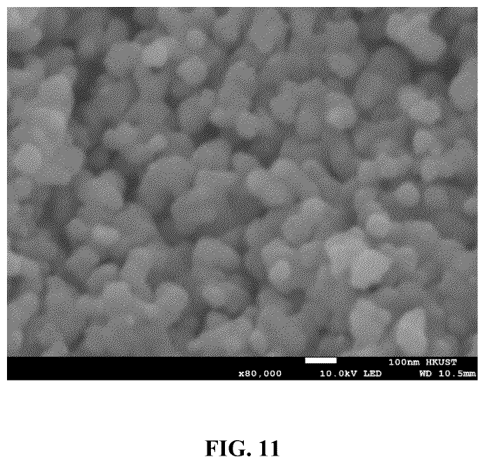

A hierarchical porous Cu was fabricated from reduction-induced decomposition of Cu₂O (RID). First, Cu₂O precursor was electrodeposited on Cu foam by galvanostatic method at current density of 10 mA cm⁻², and the process was terminated once accumulative charges reaching 18 C cm⁻². The electrolyte contained 3 M lactic acid, 0.4 M CuSO₄ and used KOH to adjust pH to 9, after which a certain concentration of AgNO₃ was added in the electrolyte as morphology controller reagent. The plating process was conducted in the two-electrode system using the Cu foam as the working electrode and Pt foil as the counter electrode. Then, the Cu₂O/Cu foam was immersed in the 200 mL 0.1 M NaBH₄ solution for 24 h to proceed with RID process. During this process, oxygen was removed from Cu₂O crystalline lattice and form nanoporous Cu structure. The nanoporous Cu electrode was washed with deionized water and ethanol solution and dried in the vacuum chamber. The SEM images of porous copper prepared by RID were shown in FIG. 11.

### Example 4

### Hierarchical Porous Cu as the Electrode for Electrochemical Organic Synthesis

Hierarchical porous electrode was used for electrochemical organic synthesis. The flow-cell was assembled using the flow-through configuration, composed of hierarchical porous electrode as cathode, carbon felt as the anode, and Nafion 117 as the separator. The catholyte contained a volume of 10 mL 0.5 M borate buffer solution (pH 9.2) and 0.05 M furfural. The anolyte was 30 mL 0.05 M K₃[Fc(CN)₆]+0.05 M K₄[Fc(CN)₆] in a 0.5 M borate buffer solution (pH 9.2). The electrolyte was bubbled by N₂ to remove residual oxygen and pumped by the peristaltic pump. The final product was evaluated by the high-performance liquid chromatography (HPLC) device to calculate the productivity and faradic efficiency.

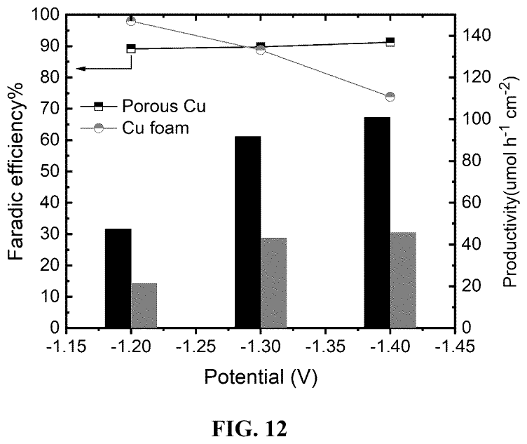

FIG. 12 showed the effect of applied potential on furfuryl alcohol productivity and faradaic efficiency using the porou Cu electrode for electrochemical organic synthesis at a flow rate of 10 mL min⁻¹. With more negative potential applied, the gap of productivity between porous Cu and Cu foam was widen. Among them, porous Cu synthesized from adding 2 mM AgNO₃ could achieve the highest 101 umol h⁻¹ cm⁻² productivity under the potential of −1.4 V, and faradaic efficiency remains 91.3%. Compared to the Cu foam, porous Cu electrode with thinner ligament size always displayed better performance in productivity under varying potential and flow rate conditions, ascribing from merits of hierarchical bicontinuous structure.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “RID” is referred to reduction-induced decomposition. In the context of the text, this process refers to the use of a reduction reaction to decompose copper oxide (Cu₂O) into porous copper (Cu) material, resulting in the creation of hierarchical porous copper. This process typically involves using a reducing agent to reduce the oxide into the corresponding metal while simultaneously generating a porous structure. These porous structures are of particular value in various applications, such as catalysis and materials science.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

### INDUSTRIAL APPLICABILITY

The invention will facilitate the development of high-energy-density, rechargeable Zn-based redox flow cells and electrochemical organic synthesis processes, such as Zn-I₂ and Zn-Br₂ redox flow cells, as well as the electrochemical synthesis of furfuryl alcohol. In the case of Zn-based redox flow cells, the primary industrial application will be in mid- to long-duration energy storage. This technology can be employed for household backup power and power stations for peak load reduction and load leveling, where an efficient and stable energy storage system is essential.

What is claimed is:

1. A two-step method for fabricating a hierarchical nanoporous metal structure, comprising the following steps:
forming a sacrificial material on a metallic structure, with the intention of forming a precursor alloy through annealing; and
dealloying the precursor alloy and the sacrificial material is removed to create a desired hierarchical nanoporous structure.

2. The method of claim 1, wherein the metallic structure has open pores larger than 1 micron.

3. The method of claim 2, wherein the metallic structure comprises open-cell a metallic foam, a metallic foil, or a metallic mesh.

4. The method of claim 3, wherein the metallic structure is made of copper, nickel, silver, tin, or a combination thereof.

5. The method of claim 1, wherein the sacrificial material comprises zinc, tin, and an element forms a homogeneous alloy precursor with the metal of the metallic structure.

6. A two-step method for fabricating a hierarchical nanoporous metal structure, comprising the following steps:
forming a thin layer of insoluble compounds on a metallic structure and utilizing the insoluble compounds as a precursor; and
removing one or more anionic components from the insoluble compound via a reduction process to create a desired hierarchical nanoporous structure.

7. The method of claim 6, wherein the metallic structure has open pores larger than 1 micron.

8. The method of claim 7, wherein the metallic structure comprises open-cell a metallic foam, a metallic foil, or a metallic mesh.

9. The method of claim 8, wherein the metallic structure is made of copper, nickel, silver, tin, or a combination thereof.

10. The method of claim 6, wherein the insoluble compound is selected from a metal oxide, a sulfide, or a hydroxide.

11. A Zn-Iodide redox flow cell, comprising:
a anode comprising at least one hierarchical nanoporous metal structure;
at least one counter electrode as a cathode;
a separator positioned between the cathode and the anode;
an electrolyte consisting of a catholyte and an anolyte; and
a two-channel peristaltic pump for propelling the electrolytes.

12. The Zn-Iodide redox flow cell of claim 11, wherein the cathode comprises a layer of nanoporous metal on top of a metallic structure of with open pores larger than one micron.

13. The Zn-Iodide redox flow cell of claim 11, wherein the hierarchical nanoporous metal structure possesses an average ligament size or a pore size of 50 nm to 200 nm.

14. The Zn-Iodide redox flow cell of claim 11, wherein the at least one counter electrode comprises carbonous electrode or Pt foil electrode.

15. The Zn-Iodide redox flow cell of claim 11, wherein the Zn-Iodide redox flow cell further comprises at least one electrolyte tank for holding the electrolyte.

16. The Zn-Iodide redox flow cell of claim 11, wherein the electrolyte comprises a neutral based solution.

17. The Zn-Iodide redox flow cell of claim 11, wherein the Zn-Iodide redox flow cell exhibits a coulombic efficiency of at least 97%, an energy efficiency of at least 75%, and a capability to operate through more than 100 cycles.

18. The Zn-Iodide redox flow cell of claim 11, wherein the Zn-Iodide redox flow cell exhibits an energy efficiency of at least 80% at the current density in a range of 20 mA cm⁻² to 40 mA cm⁻².
